(19) United States
(12) Patent Application Publication
(10) Pub. No.: US 2021/0209220 A1
(43) Pub. Date: Jul. 8, 2021

(54) REQUESTING ACCESS TO A SERVICE

(71) Applicant: Hewlett-Packard Development Company, L.P., Spring, TX (US)

(72) Inventors: Thalia Laing, Bristol (GB); Joshua Joshua Schiffman, Bristol (GB)

(73) Assignee: Hewlett-Packard Development Company, L.P., Spring, TX (US)

(21) Appl. No.: 17/056,076

(22) PCT Filed: Oct. 17, 2018
(86) PCT No.: PCT/US2018/056325

§ 371 Date: Nov. 17, 2020

(51) Int. Cl. G06F 21/44

(52) U.S. Cl. CPC G06F 21/44; G06F 2221/2129

(57) ABSTRACT

There are disclosed techniques for anonymously accessing to services, e.g., in remote locations. According to a method, an ephemeral identity may be generated. A token associated to the ephemeral identity may be requested. The request may have a signature based on the persistent identity. The requested token may be received. The token may have signature of a token issuer. In case of intention of accessing a service, the token may be submitted.

### BACKGROUND

In distributed networks, authorization schemes may permit access to services by authorized users. In some examples, the user requesting the access may provide a token to the service provider. The token demonstrates that the user has been authorized, e.g., by a token issuer.

### FIGURES

FIG. 1 shows an example of a user device.

FIG. 2 shows an example of a method.

FIG. 3 shows an example of a method.

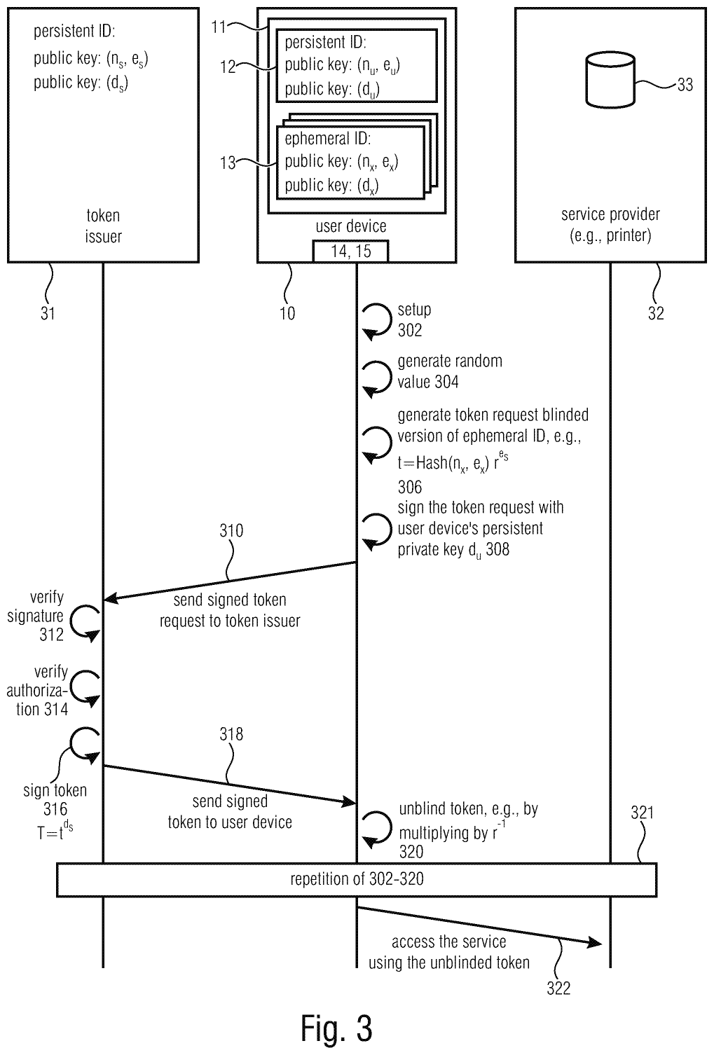

FIG. 4 shows an example of a system.

FIG. 5 shows an example of a processor system.

### EXAMPLES

In several systems, such as distributed computer networks, local area networks etc., it is in general requested to authorize user devices before granting them the access to a service (e.g., in a remote device). Often, user devices shall provide credentials, such as tokens granted by a token issuer, to demonstrate that they are authorized. Notwithstanding, there arises the possibility that, by fraudulently using information associated to the user device stored at the token issuer, the user device requesting the service access is identified. For example, a curious administrator, knowing the public key of the user device (that is stored in the token issuer), may recognize the user device from the token.

In order to cope with such inconvenience, there is provided a user device comprising a storage, a token retriever unit, and a service access unit (the token retriever unit and the service access unit may be the same device or different devices). The storage may store a persistent identity of the user device, a plurality of ephemeral identities, and a plurality of tokens for accessing to a service provider. The token retriever unit may: generate a plurality of token requests, each being a blinded version of an ephemeral identity selected among the plurality of ephemeral identities; sign the selected token request with a signature associated to the persistent identity of the user device; send the signed token request associated to the selected ephemeral identity; and receive, from the token issuer, a token associated to the token request and signed with a signature associated to the persistent identity of the token issuer; and store the token in the storage.

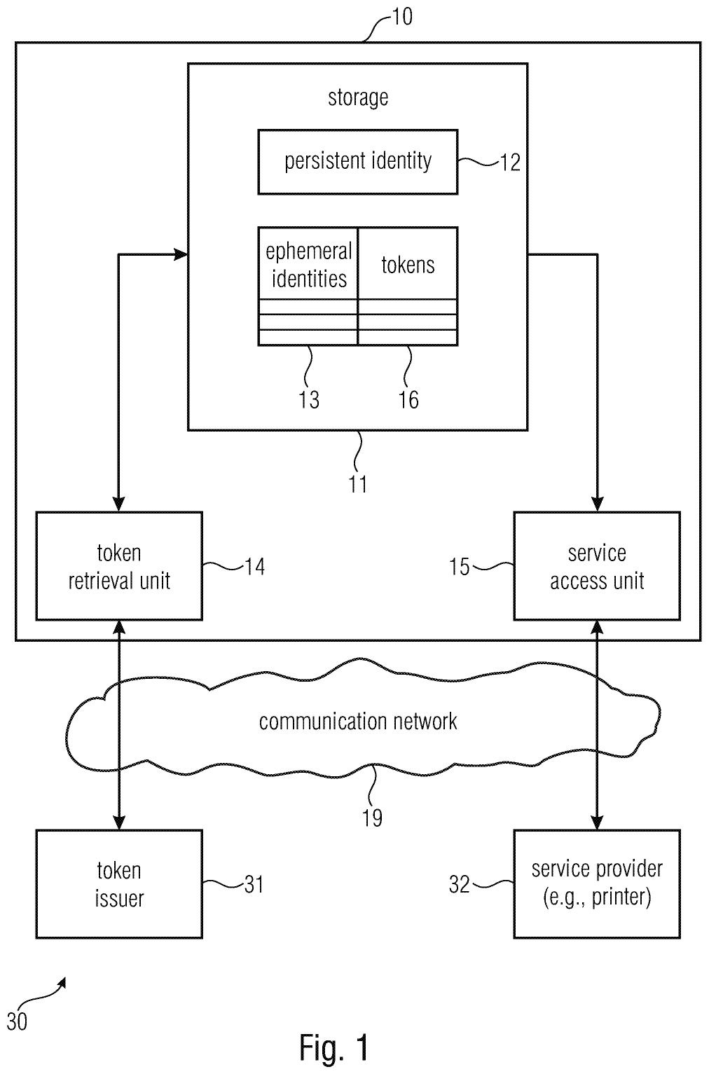

FIG. 1 shows an example of a user device 10. The user device 10 may be, for example, a processor-based or FPGA-based system, such as a personal computer, PC, laptop, smartphone, etc. The user device may be connected, e.g. via a communication network 19, to a token issuer 31 and a service access unit 32 (the token issuer 31 and the service access unit 32 may be the same device or different devices). A system 30 may be formed by user device 10, the token issuer 31 and the service access unit 32. The Communication network 19 (or another communication link) may comprise a communication infrastructure, and wired and/or wireless communication channels. The user device 10 (e.g., on the basis of selections by a human user) may, in some cases, intend to access the service provider 32 to obtain a service. Where the service provider 32 is or controls a storage unit, the user device 10 may access the service provider for anonymously storing, retrieving and/or deleting data, for example. Where the service provider 32 is a printer (or a device controlling a printer), the user device 10 may access the service provider for anonymously printing, for example, and/or for anonymously storing, retrieving and/or deleting data, for example, in a storage device associated to the printer.

The user device 10 may comprise a storage 11. The storage 11 may comprise a storage unit and/or a collection of storage units, such as a random-access memory, RAM, a flash memory, a read-only memory, ROM, etc.

The storage 11 may store, for example, a persistent identity 12. The persistent identity 12 may be such that it does not change with time. In some examples, the persistent identity 12 may include a public/private key pair, with a public key (which anyone knows) and a private key (which is secret). Other techniques are possible.

The storage 11 may store a plurality of ephemeral identities 13 (in some cases, one identity may be stored). In some examples, each ephemeral identity 13 may include a public/private key pair, which a public key and a private key. The ephemeral identities 13 may be generated, for example, by the user device 10, e.g., in a setup session, and/or by an external device. The ephemeral identities 13 may be generated by an external entity (different from the entity that will subsequently grant the token and/or that will permit the access to the service), and stored in the storage 11, e.g., in a setup or offline session. The ephemeral identities 13 may be, in examples, generated on line, whenever necessary, without waiting for a new setup session. The procedures for generating the ephemeral identities 13 may be non-deterministic, so that the ephemeral identities 13 cannot be inferred by external devices.

The user device 10 may comprise a token retrieval unit 14. The token retrieval unit 14 may be formed, for examples, by instructions stored in a non-volatile storage unit, for example, and/or hardware unit(s). The token retrieval unit 14 may access, for example, to the storage 11 and/or may obtain the persistent identity 12 and/or ephemeral identities 13.

The token retrieval unit 14 may select (e.g., in a random fashion) one of the ephemeral identities 13 (in the case where there is just one, no selection is performed).

From the selected ephemeral identity, the token retrieval unit 14 may generate a token request. The token request may be or include a blinded version (e.g., obtained by multiplying, by a random number, a value associated to the selected ephemeral identity) of the related ephemeral identity. The token retrieval unit 14 may sign the selected token request with a signature associated to the persistent identity 12 of the user device 10. Therefore, in examples, the token request may have a signature based on the persistent identity 12 of the user device 10, hence certifying the identity of the user device 10, but, additionally, the blinded version of the related ephemeral identity 13, which is unknown to any other device.

The token retrieval unit 14 may send (e.g., via communication unit(s)) the signed token request to a token issuer 31, which may be an external device. The token issuer 31 may perform an authorization process, e.g., by verifying the signature based on the persistent identity 12 of the user device 10. Once the token issuer 31 has verified the authorization of the user device 10, the token issuer 31 may send the token to the user device 10 (e.g., via communication unit(s)). The token may be, for example, a version of the token request, signed by the token issuer 31 using the persistent identity of the token issuer 31. In examples, the token as provided by the token issuer 31 may result to be a version of the user device's ephemeral identity signed the token issuer (using the token issuer's persistent identity).

Once received the token, the token retrieval unit 14 may, for example, store a version of the token in the storage 11 as token 16. The token 16 may be associated to the particular ephemeral identity 13 from which the token 16 has been generated.

The user device 10 may comprise a service access unit 15. The service access unit 15 may be used, for example, for accessing to a service provider 32, such as a remote device, to anonymously store and/or retrieve and/or data and/or for anonymously printing. (The user device 10, the token issuer 31, and the service provider 32 may form the system 30.)

The service access unit 15 may, for example, access the storage 11 to retrieve ephemeral identities 13 and/or tokens 16 (in the storage 11, ephemeral identities 13 may be associated to the related tokens 16). The selection of the tokens from the storage 11 may be according to a random selection fashion. The selection of the tokens may follow a different order from the order with which the tokens have been stored.

For example, the service access unit 15 may select one token among the plurality of stored tokens 16, and/or may generate a service access request to a service provider. The service access request may be based, for example, on the stored token 16. As the stored token 16 is signed by the token issuer 31, the access will be authorized. Further, the token 16 is signed using the corresponding ephemeral identity 13, and the persistent identity of the user device 10 may be kept anonymous.

The fact that the user device 10 may request a plurality of ephemeral identities and/or a plurality of token requests before sending the service access request increases security: the token issuer 31 and the service provider 32 cannot identify the user device 10 among a plurality of user devices requesting access to the services. Therefore, several token requests, at different time instants, may be transmitted by any user device in advance with respect to (e.g., years before) the service access request. Accordingly, it will not be possible to identify the user device when the latter has performed a service access request.

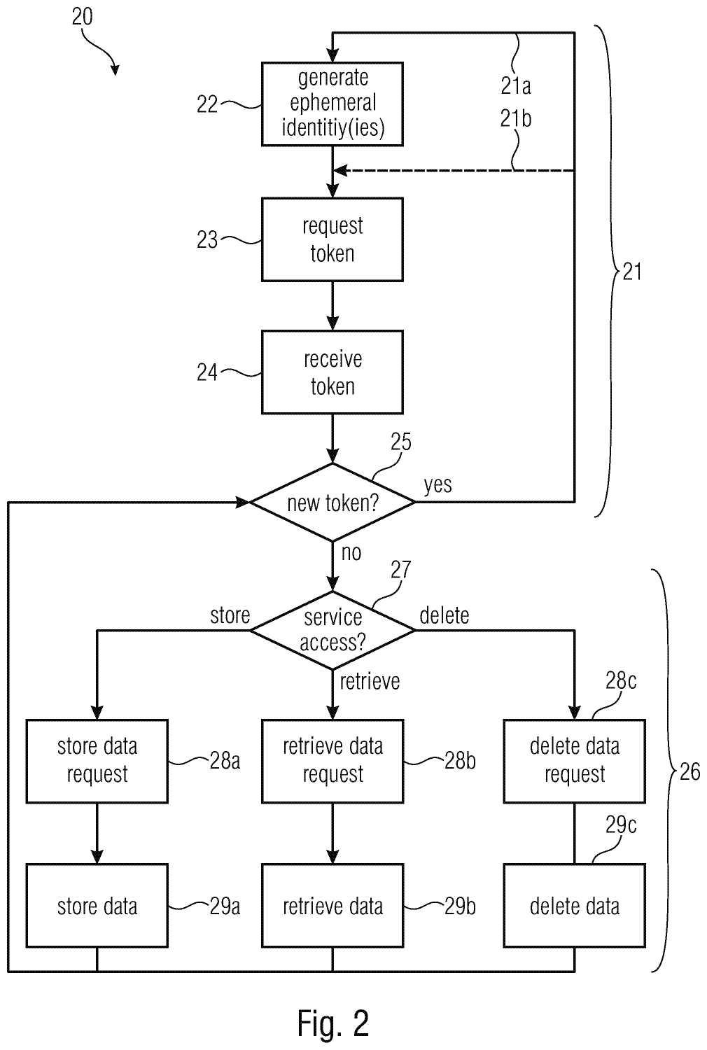

FIG. 2 shows a method 20, which may be performed, for example, by the user device 10 (or by another device).

The method 20 may comprise a cycle 21 for collecting, a plurality of tokens (e.g., tokens 14), e.g., from a plurality of ephemeral identities (e.g., 13), e.g., stored in the storage 11. The cycle 21 may be performed, for example, by a token retrieval unit (e.g., the retrieval unit 14, e.g., in cooperation with the storage 11). The cycle 21 may be iterated, for example, at least twice (in different examples, one iteration may be performed).

The method 20 may include (e.g., in cycle 21) a plurality of iterations, each of them permitting to obtain an additional token, e.g., from a token issuer (in different examples, one iteration may be performed, without cycling). Cycle 21 may be performed, in some examples, in a setup and/or offline session.

The method 20 may include (e.g., in cycle 21) a block 22 of generating an ephemeral identity (in variants, a plurality of ephemeral identities may be generated). Each ephemeral identity may comprise a public/private key pair, for example. Ephemeral identities may be identities of a user device (e.g., user device 10).

The method 20 may include (e.g., in cycle 21) a block 23 of requesting a token associated to the ephemeral identity (the request, which may be performed by sending a token request as discussed above may have a signature based on the ephemeral identity).

The method 20 may include (e.g., in cycle 21) a block 24 of receiving the requested token, the token having a signature from a token issuer (e.g., the token issuer 31).

The method 20 may include (e.g., in cycle 21) a block 25 of deciding whether to perform a new iteration of the cycle 21. In some examples, at least two requests may be performed. The different iterations may be performed at different time instants, so as to avoid that an external entity (such as the service provider and/or the token issuer, for example) associates the request to the specific device. Iterations 21a may be performed when each ephemeral identity is generated in correspondence of the iteration. Iterations 21b may be performed when a plurality of ephemeral identities is generated at block 22 in advance (e.g., in an offline session).

The token request may be anonymous, in the sense that the token request lacks any information regarding the persistent identity of the user device.

The method 20 may comprise a cycle 26 for accessing a service. The cycle 26 may be operated, for example, by a service access unit (e.g., the service access unit 15). The cycle 26 may comprise a block 27 for deciding whether a service and/or which service is to be obtained. For example, a service of storing data 29a, retrieving data 29b, and/or deleting data 29c may be intended to obtain. Other services may be requested, according to the examples, such as anonymously printing. Each of the services may be requested in case of intention of accessing to one service, by submitting one token selected from the received tokens, at blocks 28a, 28b, and/or 28c. After the service (at 29a-29c) is provided, new choices between cycles 21 and 26 may be performed, e.g., at blocks 25 and/or 27.

At any request of access to a service, the token may be signed using the private key corresponding to the ephemeral identity 13.

Examples of the method 20 and/or of operations of the user device 10 are here discussed in deeper detail. Examples hereinbelow are mainly directed to RSA procedures, but different techniques may be implemented.

A user device (e.g., the user device 10) may have a persistent identity, which may be a public/private key pair (pkₚ, skₚ). The user device 10 may be in a network (e.g., 19) with a plurality of other user devices, e.g. each having a public/private key pair. A token issuer (which may be the token issuer 31) may have knowledge of the user devices which are authorised to use a particular service (e.g., a localized device to be used as a storage location and/or for printing).

Each user device may collect several tokens from the token issuer (e.g., by iterating the cycle 21 several times). The token issuer may be configured to grant tokens to authorised user devices and to deny the tokens to unauthorized user devices. In examples, the user devices are not compelled to immediately request a service after having obtained a token. Each user device may request the service subsequently, after an undetermined amount of time, to a service provider. The service provider (e.g., a service provider 32) does not learn anything about the data being stored, e.g., which user device obtains the service. User devices may therefore anonymously obtain services such as storing data, requesting a copy of the data, and/or request data to be deleted, and/or printing.

Hereinafter, different procedures are discussed, each of which may be implemented individually or in combination with other procedures, according to examples.

Procedure “setup”: A user device (e.g., the user device 10 and/or a device performing the method 20) may run a setup procedure, which may generate at least one ephemeral identity such as an ephemeral public/private key pair (epk_{i,j}, esk_{i,j}). The procedure “setup” may be performed in block 22 and/or by the token retrieval unit 14, for example.

Procedure “get_token”: The user device may send a token request to a token issuer (e.g., the token issuer 31). The token request may comprise a blinded version of a previously generated ephemeral key. The token request may be signed using the user device's persistent identity. The token request may be signed by the user device (e.g., using a signature based on the user device's persistent identify), so as to permit the token issuer to recognize the user. When the token issuer receives a token request from an authorised user device, the token issuer may sign the token request using the token issuer's persistent private key, thereby generating the token. After then the token issuer may return the token to the user device that has sent the token request. The procedure “get_token” may be performed at blocks 23 and 24 and/or by the token retrieval unit 14, for example.

Procedure “unblind_token”: This procedure may reveal a valid signature of the token issuer on the token request received by the user device. The unblinded version of the token may be for example stored (e.g., as token 16, e.g., in the storage 11) for future use. The procedure “unblind_token” may be performed in correspondence to the reception of the token at block 24 and/or by the token retrieval unit 14, for example.

The procedures above may be performed at undetermined instants and/or in an undetermined number of iterations (e.g., in offline sessions and/or whenever necessary). A user device may run procedures such as the setup, and/or get_token and/or unblind_token procedures multiple times, to accumulate several tokens in advance and to store them in the storage. This operation permits to increase anonymity. For example, if a user device requests a token but uses the token after an indeterminate time period, the service provider and/or the token issuer is not able to correlate the subsequent data access requests to the tokens. Accordingly, anonymity may be provided by multiple users holding tokens. The more tokens granted, the stronger the anonymity.

Other procedures are now discussed, which may be performed whenever a user device intends to obtain a particular service. These procedures may be performed, for example, by a service access unit such (e.g., the service access unit 15) and/or in a cycle such as the cycle 26. In examples, the services requested may be services such as services 29a-29c.

Procedure “send_data”: used to store data in a remote device, algorithm. The user device may encrypt the data to be stored. Symmetric or asymmetric cryptography may be used, for example. Then, the user device may send the encrypted data to the storage device (service provider), along with their ephemeral public key epk_{i,j} and/or the token corresponding to their ephemeral public key. All this data may be signed with the ephemeral private key esk_{i,j}.

Procedure “get_data”: when the user wishes to retrieve a copy of their data, the procedure “get_data” may be invoked. Accordingly, the ephemeral public key corresponding to the desired data, epk_{i,j}, may be transmitted to the storage device, along with a message retrieval flag, for example. This information may be signed using the corresponding ephemeral private key esk_{i,j}. This message may not be signed by the user device's persistent identity.

Procedure “delete_data”. With this procedure, the user device may send the ephemeral public key corresponding to the desired data, epk_{i,j}, along with a delete flag. This information may be signed using the corresponding ephemeral private key epk_{i,j}. This message may not be signed by the user device's persistent identity.

More detailed examples are discussed below. An example is provided based on Rivest-Shamir-Adleman, RSA, procedures. However, other examples, may be provided, e.g., based on bilinear pairings procedures (e.g., Mikimoto procedures).

With procedures such as RSA, each identity (either persistent or ephemeral) is based on a public/private key pair. The encrypting entity (which may be a device) encrypts a message using the public key of the pair, while a decrypting device decrypts the message using the private key of the pair. The public key is in general known by any other device, but the device that has the private key (which is secret) may decrypt the encrypted message without other devices being able to do so (the public key is not capable of decrypting the message, even if the message has been decrypted using the same public key). In general terms, a message m (m may be intended as a numeral, but may be associated to a string in plaintext) may be encrypted so as to generate the encrypted message c (c may be intended as a numeral, but may be associated to a string which cannot be read by a human) with the operation m^{e} mod n, where e and n constitute a public key. The encrypted message may subsequently be decrypted by virtue of the relationship m=c^{d} mod n, where d is a private key. In the RSA procedure, the public/private keys are chosen so as to verify n=pq, with p and q coprime, and d=e⁻¹ mod (p−1)(q−1).

Notably, public/private key pairs may also be used to sign messages, using the public/private keys in reversed fashion than for encryption: a signing entity may use the private key d (which no one else knows), and the signature may be verified by any other entity simply by using the public key (n, e). Signatures are not used for encrypting a message, but for guaranteeing the provenience of a message from a particular entity.

Operations such as signing tokens and/or generating token requests may be performed using these signature strategies.

In examples above and below, reference is made to modulo operations (indicated with “mod”), e.g., in which the outcome of the operations is the rest of the integer division (different strategies may be used).

Reference may be made, for example, to the system 30, which comprises a user device (which may be the user device 10 and/or a device performing the method 20), a token issuer (e.g., the token issuer 31) and/or a service provider (which may be the service provider 32). (The token issuer 31 and the service provider 32 may be the same device in some examples.)

The token issuer's persistent public key may be (nₛ, eₛ) with corresponding private key (dₛ). The user's persistent public key may be (nᵤ, eᵤ) and the corresponding private key is (dᵤ).

In a procedure “setup” 302, the user device may generate an ephemeral public/private key pair, or select the ephemeral public/private key pair from a plurality of ephemeral public/private key pairs (stored, for example, in the storage 11). The ephemeral public key of the user device may be indicated with (nₓ, eₓ), while the private key may be indicated with (dₓ).

In the procedure “get_token” (e.g., performed by a token retrieval unit such as the token retrieval unit 14 and/or at the block 23), the user device may retrieve the token issuer's public key, (nₛ, eₛ).

The user device may generate a random value r which is co-prime to n, which is not known by any other device at 304. The user device may generate a blinded version of the ephemeral identity at 306. The user device may compute the inverse of r mod nₛ, which is (r mod nₛ)⁻¹. The user device may generate the token request as a hash version of the ephemeral identity:

$$t = Hash ( {n}_{x} , {\text{?}}_{x} ) {r}^{{e}_{s}} {mod n}_{\text{?}}$$

$$\text{?} \text{indicates text missing or illegible when filed}$$

Hash( . . . ) may refer to a cryptographic hash function, which may be a non-invertible function and/or which may map a string of undetermined length into a string of determined length (other solutions may be provided). In examples, the hash may be used so that the signature is produced on a short fingerprint of the message (the output of the hash function). The blinding may be achieved by multiplying by the value r. Therefore, in some examples, the use of the hash function may be avoided.

As can be seen, the token request t may be a function of r [symbol] . The random value r is not known by other devices, while eₛ may be the token issuer's public key. Therefore, the token request may be a blinded version of the ephemeral public key (nₓ, eₓ) of the user device. Notably, the token issuer (relying on the token issuer's private key) will be able to sign the message, but will not be able to unblind it as it will not aware of the random value r.

The user device may sign the token request t using the user device's persistent private key, dᵤ, at 308.

At this point, the user device may send, at 310, the token issuer request t to the token issuer. The token issuer (which is aware of the user device's persistent public key) may confirm whether the request has been signed by an authorised entity, e.g., by verifying the signature using the device's persistent public key (nᵤ, eᵤ).

If the user device's signature in the token request is valid, the token issuer may further verify whether the user is authorised, at 314.

If the user is authorized, the token issuer may generate a token, which may be a signed version of the token request, at 316. For example, the signed version of the token request may be signed using the token issuer's private key dₛ. The token may therefore result:

$$T = {t}^{{d}_{s}} {mod n}_{\text{?}}$$

$$\text{?} \text{indicates text missing or illegible when filed}$$

Notably, the token issuer, which has verified the token request, is not aware of the ephemeral identity of the user device. For example, the ephemeral public key (nₓ, eₓ) is hidden in the blinded version of the token request t by virtue of the unknown random value r. However, the token issuer may notwithstanding recognize the signature in the token request (signed using the persistent identity of the user device) and provide the granted token to the user, the granted token having the token issuer's signature (signed with the token issuer's identity).

The token issuer may send the token to the user device, at 318.

When the user device obtains the token T, the user device may unblind the token T at 320. For example, the user device may multiply the received token by r⁻¹ in order to compute the unblinded token. It is noted that in this case ( [symbol] ) [symbol] r⁻¹=1 mod [symbol] . The unblinded token may be, for example:

$$t = Hash ( {n}_{x} , {\text{?}}_{x} ) {r}^{\text{?} - 1} = Hash ( {n}_{x} , \text{?} )$$

$$\text{?} \text{indicates text missing or illegible when filed}$$

It is noted that dₛ is the token issuer's private key, which is not known by the user device, and therefore may be used as a signature, hence granting to the user device access to a service provider in the future.

At 321, the passages 302-320 may be repeated indeterminately. Other user devices different from the user device 10 may collect other tokens.

Therefore, in future uses (e.g., at 322), the user device may access the token issuer by providing the unblinded version of the token.

For example, for performing a store data, the user device may initiate a procedure store_request by may sending to the service provider at least one of the following data, collectively called “pub_key”:

| | |
|---|---|
| pub_key | The user device's ephemeral public key, such as (nₓ, eₓ). |
| token | The unblinded token corresponding to the public key, |
| | e.g., [symbol] |
| data | The data to be transmitted (e.g., an encrypted version thereof, |
| | e.g., encrypted according to any encryption technique) |
| signature | A signature on (pub_key, token, data) computed using the |
| | ephemeral private key (dₓ). |

[symbol]

indicates data missing or illegible when filed

Accordingly, the data may be stored by the service provider in such a way that the service provider has knowledge of the ephemeral identity of the user device but not of the persistent identity, even if the access may be granted on the basis of the signature indicated by the exponent dₛ in the token.

It is noted that the user device may transmit the ephemeral public key (nₓ, eₓ) in the service access request, so as to permit the device to verify the token (which is Hash(nₓ,eₓ) [symbol] ). The service provider, having knowledge of the token issuer's public key and of the signature in the token, may verify the token.

A user device may also encrypt the data to be stored. The data may for example, be encrypted using any encryption technique, independently on the signature techniques described here which render anonymous the user device.

When the user device intends to retrieve a copy of their data, a request may be sent to the service provider. The request may be of the type (pub_key, retrieve_request, sig_{dₓ}(pub_key, retrieve_request)).

In a variant, while the signature to store data (the store_request procedure) may be included, the signature for retrieving the data (retrieve_request procedure) may not be included. This allows file sharing between different users in the system. For example, a user without a signed token may not be able to store data but may be able to retrieve data stored by another user. In case the user device intends to delete the stored data, user device may send a request (procedure “delete_request”), which may be as (pub_key, delete_request, sig_{{dx}}(pub_key, delete_request)).

Examples above and below may be completely transparent to the token issuer and the service provider: it is simply possible to use common devices for these entities.

In particular, in examples above, the service provider 32 may be a printer (e.g., a printer connected to a network in a LAN). The service to be provided may be, for example, a print job of a file from an anonymous user device. In other cases, the printer may provide storage data and/or print services without knowing which user device is serving. It has been noted, in fact, that printers tend to have storage space in excess, and they may put it at disposal of users, in case of necessity. Applications such as file sharing may be obtained between anonymous user devices, for example. Notably, even curious network administrators cannot identify the users: it is possible to arrive, at best, to the ephemeral identity, but not to the persistent identity.

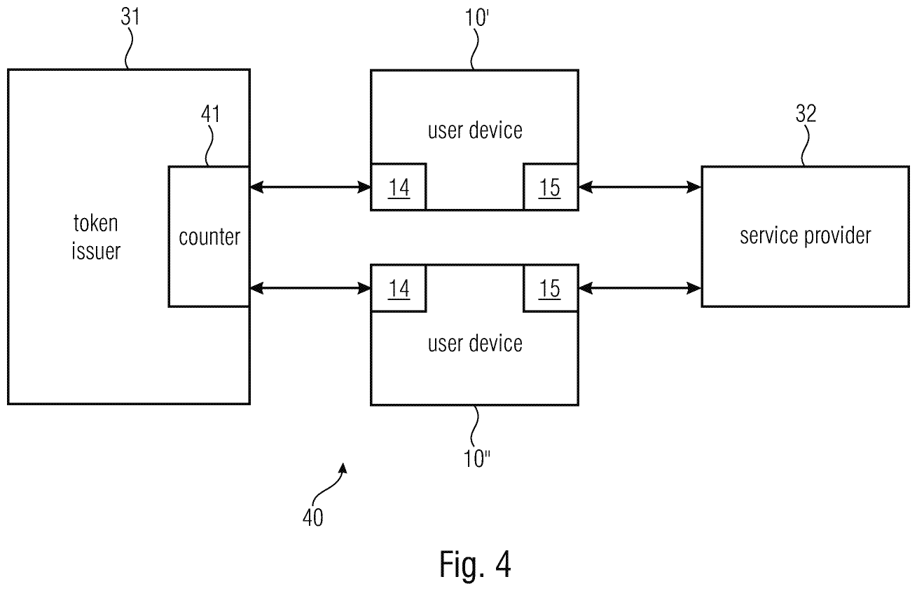

FIG. 4 shows a system 40 comprising at least a first user device 10′ and a second user device 10″ (each of them may be, for example, as user device 10 and/or a user device implementing method 20), which may be different user devise of a same network. The system 40 may comprise, for example, a token issuer (e.g., the token issuer 31) and/or a service provider (e.g., the service provider 32).

In examples, the token issuer 31 may comprise a token counter 41, which may count the number of tokens granted to each user device, e.g., in a determined time interval. Accordingly, over a maximum number of tokens, no further tokens may be granted, for example.

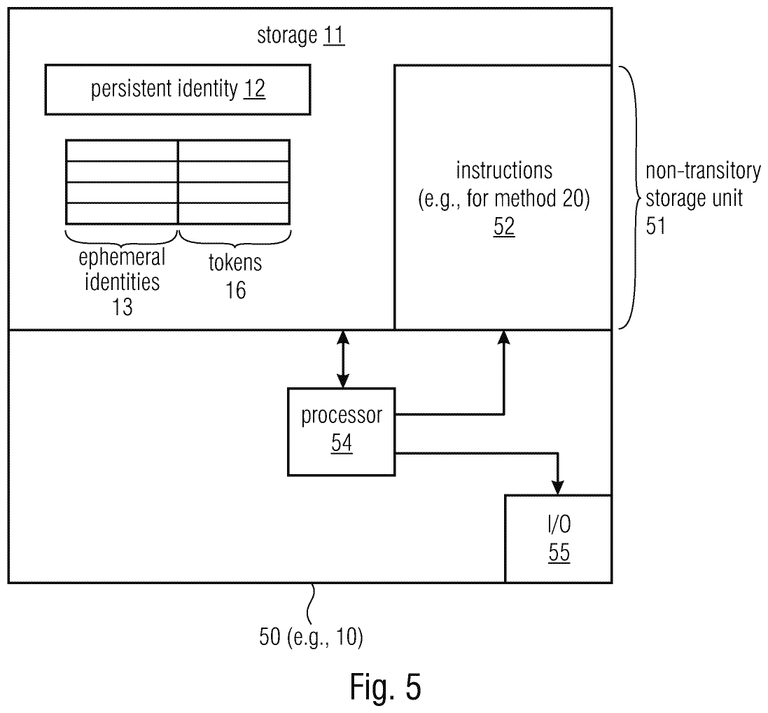

In examples, the token issuer may implement a technique to ensure the user device does not save too many tokens. For example, the token issuer may implement an expiry system. For example, there may be a deadline for each token, after which the token will expire. FIG. 5 shows a processor system 50, which may implement a user device such as the user device 10 and/or may implement the method 20 and/or other procedures discussed above. The processor system 50 may comprise a processor 54 and input/output, I/O, unit 55 to be connected to other devices (e.g., token issuer and/or service provider, e.g., via network 19). The processor system 50 may comprise a storage 11, which may be as above. The system 50 may comprise a non-transitory storage unit 51 which may store instructions 52 which, when executed by the processor 54, may cause the processor to:
generate and/or select a request as a blinded version of an ephemeral identity (in some cases, the selection is among a plurality of the ephemeral identities);
sign the generated token request with a signature associated to a persistent identity (e.g., the persistent identity 12 of the processor system 50);
send the token request to a token issuer; and
receive, from the token issuer, a signed token;
store the token in the storage 11 (a plurality of tokens may be stored, each being associated to the ephemeral identity from which the token has been generated);
in case of necessity of accessing a service, generate a service access request and send it to a service provider, the service access request including the token (the token may be selected from a plurality of tokens stored in the storage 11).

Any of the features discussed above may be implemented using the processor system 50. Any of the features of the processor system 50 may be used to embody the invention in the examples above.

In examples, above, tokens and/or token requests may also be generated so as to embed information therein.

1. A user device comprising:
a storage, to store:
a persistent identity of the user device;
a plurality of ephemeral identities;
a plurality of tokens for accessing a service provider;
a token retriever unit, to:
generate a plurality of token requests, each being a blinded version of an ephemeral identity selected among the plurality of ephemeral identities;
sign the selected token request with a signature associated to the persistent identity of the user device;
send the signed token request associated to the selected ephemeral identity; and
receive, from the token issuer, a token associated to the token request and signed with a signature associated to the persistent identity of the token issuer;
store the token in the storage;
a service access unit, to:
select one token among the plurality of stored tokens;
generate a service access request to a service provider, the service access request including the selected token.

2. The user device of claim 1,
wherein the service access unit is to send the service access request to the token issuer anonymously, the service access request lacking of information regarding the persistent identity of the user device

3. The user device of claim 1,
wherein the service access unit is to send the service access request so as to include an ephemeral public key of the selected ephemeral identity of the user device.

4. The user device of claim 1,
wherein the service access unit is to sign the token using the corresponding ephemeral identity.

5. The user device of claim 1,
wherein the service access unit is to randomly select the token among the plurality of stored tokens and/or to select the tokens with an order different from the order with which tokens are stored.

6. A system comprising at least one user device according to claim 1, the token issuer and/or the service provider.

7. The system of claim 6,
wherein the service provider is a printer or a device controlling a printer.

8. The system of claim 7,
wherein the service is a print job requested from the user device, the user device being anonymous.

9. The system of claim 6,
wherein the service provider has storage space and the service to be provided is at least one of storing data, retrieving the data, and deleting the stored data.

10. The system of claim 6,
wherein the token issuer includes a token counter, so as to count the number of tokens provided to each user device, to deny the provision of further tokens after a maximum threshold is reached.

11. A method comprising:
generating an ephemeral identity;
requesting a token associated to the ephemeral identity, the request having a signature based on the persistent identity;
receiving the requested token, the token having a signature from a token issuer;
in case of intention of accessing a service, submitting the received token.

12. The method of claim 11, further comprising repeating generating, requesting and receiving in at least a plurality of iterations.

13. The method of claim 11, further comprising repeating the method for each of a plurality of user devices.

14. A method including:
a first user device performing the method of claim 11, so that the submitted token is signed with the corresponding ephemeral identity, the service being storing data into a service provider;
the first user device storing the data on the service provider;
a second user device accessing a service for retrieving the data provided without signing the request with the ephemeral identity corresponding to the token; and
the second user device retrieving the stored data from the service provider.

15. A non-transitory storage unit storing instructions which, when executed by a processor, cause the processor to:
generate and/or select a request as a blinded version of an ephemeral identity;
sign the generated token request with a signature associated to a persistent identity;
send the token request to a token issuer;
receive, from the token issuer, a signed token;
store the token in the storage; and
in case of necessity of accessing a service, generate a service access request and send it to a service provider, the service access request including the token.
